(19) United States
(12) Patent Application Publication
(10) Pub. No.: US 2025/0311677 A1
(43) Pub. Date: Oct. 9, 2025

(54) AGRICULTURAL MACHINE EXTRACTOR ASSEMBLY, DEFLECTOR FOR AGRICULTURAL MACHINE EXTRACTOR ASSEMBLY AND AGRICULTURAL MACHINE

(71) Applicant: CNH Industrial Brasil Ltda., Nova Lima (BR)

(72) Inventors: Thiago Silveira Simonetti Norberto, Piracicaba-SP (BR); Joao Augusto Marcolin Lucca, Piracicaba-SP (BR); Jean Carlos Pereira de Camargo, Piracicaba-SP (BR); Alan Patrick Dos Santos, Piracicaba-SP (BR)

(21) Appl. No.: 19/170,524

(22) Filed: Apr. 4, 2025

(30) Foreign Application Priority Data
Apr. 4, 2024 (BR) 10 2024 006673 1

(51) Int. Cl. A01F 12/54; A01D 45/00; A01D 45/10

(52) U.S. Cl. CPC A01F 12/54; A01D 45/003; A01D 45/10

(57) ABSTRACT

In one aspect, an extractor assembly for an agricultural machine includes a deflector designed to cause air passing through external walls of the extractor assembly to intersect, which reduces the air flow velocity and improves the mixing of crop waste, resulting in a more uniform waste exhaustion and allowing better direction of said waste out of the agricultural machine. In one implementation, the deflector includes flat plate that defines a perimeter adapted to be coupled to an extractor hood of the extractor assembly. The deflector may also include a fixing plate and a fixing assembly.

### FIELD OF THE INVENTION

The present invention relates, in general, to an extractor assembly comprising at least one deflector, particularly those intended for harvesting tall, stemmy plants, such as sugar cane and sweet sorghum. The invention also relates to a deflector for an extractor assembly of an agricultural machine. Finally, the invention also relates to an agricultural machine intended for harvesting tall, stemmy plants, such as a sugar cane and sorghum harvester, which comprises at least one extractor assembly, comprising the deflector, as per the object of the present invention.

### BACKGROUND OF THE INVENTION

There are numerous models of agricultural equipment and machines in the state of the art that have been developed to increase productivity in the harvesting of various types of plant crops, for example, grain harvesters, forage harvesters and also harvesting machines for so-called tall and stemmy plants, such as sugar cane and sweet sorghum.

The machines used to harvest these tall, stemmy plants are designed and developed to enable the harvest of this specific type of crop, because their intrinsic characteristics require specific conditions for their adequate processing, from cutting to transfer to the transshipments and/or trailers.

In this context, it is known that these machines for harvesting tall, stemmy plants comprise a chassis that supports a set of mechanisms, including a series of conveyor rollers and choppers responsible for guiding and chopping the sugarcane into billets that are transferred to the transshipments and/or trailers via an elevator.

As those skilled in the art should be aware, along with the billets, waste formed by pieces of light waste such as dust, dirt, leaves, branches, roots, etc. are transported, which are separated from the sugarcane billets and expelled from the harvester through equipment called extractors, or extractor assemblies, which are normally positioned at the exit of the set of chopping rollers, called the primary extractor assembly, and at the upper end of the elevator assembly, which is called the secondary extractor assembly.

These extractor assemblies are comprised of a cleaning chamber and a ventilation and extraction assembly, which are responsible for pulling and directing the harvested waste out of the harvester. More specifically, the cleaning chamber is intended to separate the light waste from the heavier billets of plants. To this end, the ventilation and extraction assembly needs to generate an upward flow that carries a certain volume of air in order to separate the waste from the sugarcane billets, expelling the light wastes and allowing the sugarcane billets to fall by gravity and be sent to the elevator assembly, in the case of the primary extractor assembly, or to the overflows and transport trailers, in the case of the secondary extractor assembly.

Extractor assemblies are widely known in the state of the art. For example, document BR102022001438-8 discloses a waste extractor assembly for an agricultural machine designed and developed to maximize the use of the air flow that passes through the cleaning chamber and, thus, increase the efficiency of the cleaning process of the harvested material before transfer to the overflows and transport trailers, aiming to reduce the transfer of waste to the latter.

Document BR102020020764-4, in turn, discloses an actuator mechanism for the hood of agricultural machine waste extractors, designed and developed to provide a practical and functional solution, but mainly low cost, regarding the extraction of wastes during the harvesting process of agricultural machine. The invention of this document has as its main objective to provide a relatively simple and low cost solution, but at the same time providing a range in terms of rotational movement of the hood to eliminate any risk of the waste flow contaminating the flow of billets that are being dumped in the overflows.

Document BR102019003809-8, in turn, refers to a waste extractor assembly for harvesting machines of tall and stemmy plants, such as sugarcane and sorghum harvesters, the waste extractor assembly being developed to improve the transport conditions of the machines, but also to optimize the lubrication of the fan bearings, ensuring adequate lubrication of the bearings. The document in question aims to solve the difficulty and complexity of accessing the fan support bearings, which causes operators and farmers to end up postponing, or even ignoring, preventive maintenance involving bearing lubrication, which can lead to relatively large losses by affecting harvest productivity.

Although the extractor assemblies from the state of the art, such as those described above, are efficient in separating light wastes from sugarcane billets and solve the technical problems they are intended to solve, they still face some difficulties arising from their design. For example, due to the complexities inherent in the air circulation inside the cleaning system, there is a tendency for light wastes to concentrate on the left side of an extractor assembly. This is the result of the combination of the cleaning system design with the specific dynamics that influence the trajectory of suspended particles during the waste exhaustion process.

This accumulation of wastes on the left side of the extractor assembly causes the wastes to exit the extractor assembly in a non-uniform manner, which makes soil management difficult after the sugarcane or sweet sorghum harvest. Furthermore, the uneven spreading of waste makes it difficult to use it, for example, for the production of biofuels which, due to regulations and upcoming environmental challenges, make up an increasingly large share of the energy matrix of large energy producers. It is observed that none of the extractor assemblies from the state of the art, as exemplified above, are concerned with solving such difficulties.

In this sense, it is noted that the design of the material cleaning systems applied to the agricultural machine from the state of the art could be improved so that there is no inadequate concentration of waste on one side of the extractor assembly and, consequently, so that the waste is expelled uniformly by the extractor assembly of the agricultural machine.

### BRIEF DESCRIPTION OF THE INVENTION

The aspects and advantages of the invention will be set forth, in part, in the following description, or may be obvious from the description, or may be learned by practicing the invention.

The present invention relates to a waste extractor assembly for an agricultural machine. The extractor assembly has a cleaning chamber superimposed by a ventilation and extraction assembly, formed by a housing within which is installed a fan configured to direct crop wastes through an extractor hood, and at least one deflector comprising a flat plate, which has a perimeter adapted to be coupled to the extractor hood of the extractor assembly, a fixing plate and a fixing assembly, in which the at least one deflector is attached to the extractor hood.

According to additional or alternative embodiments of the present invention, the following features, and their possible variants, may also be present, alone or in combination:
the at least one deflector is attached to the extractor hood by means of the fixing plate and the fixing assembly;
the fixing plate is attached to a front internal surface of the extractor hood and the fixing assembly is attached to a rear internal surface of the extractor hood by means of screws;
the fixing plate is welded to a front internal surface of the extractor hood and the fixing assembly is welded to a rear internal surface of the extractor hood; and
the fixing plate is attached to a front internal surface of the extractor hood and the fixing assembly is attached to a rear internal surface of the extractor hood by means of adhesives.

In order to overcome the drawbacks of the prior art mentioned above, among others, the present invention also relates to a deflector for an extractor assembly of an agricultural machine, in which the deflector comprises a flat plate, which comprises a perimeter adapted to be coupled to an extractor hood of an extractor assembly of an agricultural machine, a fixing plate and a fixing assembly.

According to additional or alternative embodiments of the present invention, the following characteristics, and their possible variants, may also be present, alone or in combination:
the fixing plate has an angle of 10° to 20° in relation to a surface of the deflector, preferably an angle of 15°;
the perimeter of the flat plate consists of a first perimeter section, a second perimeter section, a third perimeter section, a fourth perimeter section, a fifth perimeter section and a sixth perimeter section;
the first perimeter section comprises a rectilinear segment; the second perimeter section comprises a rectilinear segment and forms an obtuse internal angle with the first perimeter section; the third perimeter section comprises a rectilinear segment and forms an obtuse internal angle with the second perimeter section; the fourth perimeter section comprises a curved segment and forms an obtuse internal angle with the third perimeter section; the fifth perimeter section comprises a curved segment and forms an obtuse internal angle with the fourth perimeter section; and the sixth perimeter section comprises a rectilinear segment, forms an obtuse internal angle with the fifth perimeter section and forms an acute internal angle with the first perimeter section;
the first perimeter section comprises a flap;
the second perimeter section, the fourth perimeter section and the fifth perimeter section comprise trims;
the first perimeter section and the second perimeter section form a cut-out adapted to fit into a support bar of the extractor hood;
the fourth perimeter section and the fifth perimeter section comprise a curvature configured to fit into the curvature of an internal surface of the extractor hood;
the fixing assembly comprises a central plate, a first side plate, a second side plate and a transverse plate connecting the first side plate and the second side plate; and
the deflector is manufactured from a metallic material, a thermoplastic material or a combination thereof.

Finally, also aiming to overcome the drawbacks of the aforementioned prior art, among others, the present invention also relates to an agricultural machine, of the type for harvesting tall and stemmy plants, which is formed by a chassis mounted on wheels or tracks, a motor and an elevator comprising a proximal end and a distal end. The agricultural machine also comprising at least one extractor assembly, in accordance with aspects of the present subject matter, installed in at least one of the proximal end and the distal end of the elevator.

These and other aspects, functions and advantages of the present invention will become better understood with reference to the following description and attached claims. The attached drawings, which are incorporated into and constitute a part of this descriptive report, illustrate the embodiments of the invention and, together with the description, serve to explain the principles of the invention.

### BRIEF DESCRIPTION OF THE FIGURES

A complete and feasible description of the present invention, which includes the best mode thereof, directed to a person of ordinary skill in the art, is presented in the descriptive report, which makes reference to the attached figures, in which:

FIG. 1 illustrates a schematic side view of a sugarcane and sorghum harvesting machine, such as those known in the prior art;

FIG. 2 illustrates a schematic view of a deflector for an extractor assembly in accordance with aspects of the present subject matter;

FIG. 3 illustrates a side view of an extractor assembly in accordance with the prior art;

FIG. 4 illustrates a rear view of the extractor assembly illustrated in FIG. 3;

FIG. 5 illustrates a rear view of an extractor assembly in which two deflectors, in accordance with aspects of the present subject matter, have been installed in an extractor hood of the extractor assembly;

FIG. 6 illustrates the extractor assembly of FIG. 5, in which the upper part of the extractor hood has been removed for better viewing of the internal part of the extractor assembly;

FIG. 7 illustrates an isometric view of the extractor assembly shown in FIG. 5;

FIG. 8 illustrates an isometric view of the extractor assembly shown in FIG. 6; and

FIGS. 8A and 8B illustrate, in detail, the attachment points between the deflector, in accordance with aspects of this subject matter, and the extractor assembly.

### DETAILED DESCRIPTION OF THE INVENTION

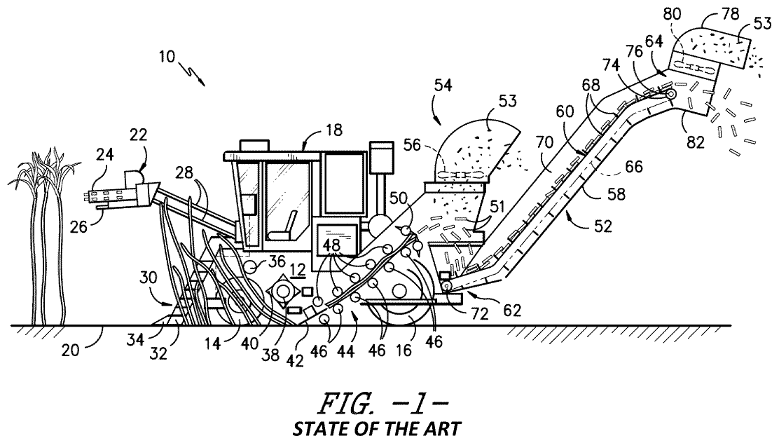

The invention will now be described with respect to its particular embodiments, with reference to the attached figures. These figures are schematic, and their dimensions and/or proportions may not correspond to reality, since they aim to describe the invention in a didactic manner. Furthermore, certain known and common construction details may have been omitted for greater clarity and conciseness of the description that is given below. The reference numerals used are repeated throughout the figures to identify identical or similar parts. The terms eventually used such as “above”, “below”, “front”, “back”, “right”, “left” etc. and their variants should be interpreted according to the guidance given in FIG. 1.

With respect now to the drawings, FIG. 1 illustrates a side view of an embodiment of an agricultural vehicle 10 in accordance with aspects of the present disclosure. As shown, the agricultural vehicle 10 is configured as a sugar cane harvester. However, in other embodiments, agricultural vehicle 10 may correspond to any suitable agricultural harvester known in the art.

As shown in FIG. 1, agricultural vehicle 10 includes a chassis 12, a pair of front wheels 14, a pair of rear wheels 16, and an operator's cab 18. Agricultural vehicle 10 may also include a primary power source (e.g., a motor mounted on chassis 12) that powers one or both pairs of wheels 14, 16 via a transmission (not shown). Alternatively, the agricultural vehicle 10 may be a track-driven harvester and therefore may include tracks driven by the drive mechanism in place of the illustrated wheels 14, 16. The drive mechanism may also drive a hydraulic fluid pump (not shown) configured to generate pressurized hydraulic fluid to drive various hydraulic components of the agricultural vehicle 10.

Additionally, the agricultural vehicle 10 may include various components for cutting, processing, cleaning, and unloading sugarcane as the cane is harvested from an agricultural field 20. For example, the agricultural vehicle 10 may include a topper assembly 22 positioned at its front end to intercept sugarcane as the agricultural vehicle 10 is moved in the forward direction. As shown, the topper assembly 22 may include both a binder disc 24 and a cutter disc 26. The binder disc 24 may be configured to bind sugarcane stalks so that the cutter disc 26 may be used to cut the tip of each stalk. Generally, the height of the topper assembly 22 may be adjustable by means of a pair of hydraulically raised and lowered arms 28 as desired by the operator.

Additionally, the agricultural vehicle 10 may include a row divider 30 that extends upward and rearward from the field 20. In general, the row divider 30 may include two spiral feed rollers 32, also known as “lollipops.” Each feed roller 32 may include a ground shoe 34, as its lower end assists the row divider 30 in separating sugarcane stalks for harvesting. Additionally, as shown in FIG. 1, the agricultural vehicle 10 may include a tipping roller 36 positioned proximate to the front wheels 14 and a projection roller 38 positioned behind the tipping roller 36. As the tipping roller 36 is rotated, the harvested sugarcane stalks are tipped while the row divider 30 gathers the stalks from the agricultural field 20 toward the interior of the machine 10. Additionally, as shown in FIG. 1, the projection roller 38 may include a plurality of intermittently mounted fins 40 that assist in forcing the sugarcane stalks downward. As the roller 38 is rotated during harvesting, the sugarcane stalks that have been tipped by the tipping roller 36 are separated and subsequently tipped by the roller 38 as the agricultural vehicle 10 continues to be moved forward relative to the field 20.

Still referring to FIG. 1, the agricultural vehicle 10 may also include a base cutting assembly 42 positioned behind the roller 38. As is generally understood, the base cutting assembly 42 may include blades (not shown) for cutting the sugarcane stalks as the cane is harvested. The blades, located on the periphery of the assembly 42, may be rotated by a hydraulic motor (not shown) driven by the vehicle's hydraulic system. Additionally, in various embodiments, the blades may be angled downward to cut the base of the sugarcane as the cane is tumbled by the roller 38.

Additionally, the agricultural vehicle 10 may include a set of one or more conveyor rollers 44 located downstream of the base chopper assembly 42 for moving the cut sugarcane stalks from the base chopper assembly 42 along the processing path. As shown in FIG. 1, the conveyor roller assembly 44 may include a plurality of lower rollers 46 and a plurality of upper rollers 48. As the sugarcane is transported across the conveyor roller assembly 44, debris (e.g., rocks, dirt, and/or the like) may also be transported or fall across the lower rollers 46 onto the field 20.

Additionally, the agricultural vehicle 10 may include a chopper assembly 50 located at the downstream end of the conveyor roller assembly 44 (e.g., adjacent to the rearmost lower and upper conveyor rollers 46, 48). In general, the chopper assembly 50 may be used to cut or chop the harvested sugarcane stalks into smaller pieces or “chunks” 51 that may, for example, measure six (6) inches (15.24 centimeters), also called billets or slugs. The fragments 51 may then be propelled toward an elevator assembly 52 of the agricultural vehicle 10 to be collected in an external receiver or storage device (not shown).

As is generally understood, pieces of waste 53 (e.g., dust, dirt, leaves, etc.) separated from the sugarcane fragments 51 may be expelled from the agricultural vehicle 10 through a primary extractor assembly 54, which is located behind the chopper assembly 50 and is oriented to direct the waste 53 away from the agricultural vehicle 10. Additionally, a fan 56 may be mounted to the primary extractor assembly 54 to generate a suction force or vacuum sufficient to capture the waste 53 and force the waste 53 through the primary extractor assembly 54. The waste 53 is then directed away from and generally in the opposite direction of the agricultural vehicle 10 through an outlet of the primary extractor assembly 54. Separated fragments 51 and heavier than the waste 53 being expelled from the extractor 54 may then fall to the elevator assembly 52.

As shown in FIG. 1, the elevator assembly 52 may generally include an elevator housing 58 and an elevator 60 extending within the elevator housing 58 between a lower proximal end 62 and an upper distal end 64. In general, the elevator 60 may include a conveyor chain or belt 66 and a plurality of paddles or slats 68 coupled to or uniformly spaced within the chain 66. The slats 68 may be configured to hold the sugarcane fragments 51 in the elevator 60 as the fragments 51 are elevated toward the top of the elevator 70. Additionally, the elevator 60 may include lower and upper sprockets 72, 74 positioned about the proximal and distal ends 62, 64, respectively. As shown in FIG. 1, an elevator motor 76 may be coupled to one of the sprockets (e.g., upper sprocket 74) to drive chain 66, thereby allowing chain 66 and slats 68 to travel in an endless cycle between proximal and distal ends 62, 64 of the elevator 60.

Additionally, pieces of waste 53 (e.g., dust, dirt, leaves, etc.) separated from sugarcane fragments 51 may be expelled from agricultural vehicle 10 via a secondary extractor assembly 78 coupled to the rear end of the elevator 58. As shown in FIG. 1, the secondary extractor assembly 78 may be located adjacent to the distal end 64 of the elevator 60 and may be oriented to direct waste 53 away from the agricultural vehicle 10. Additionally, a fan 80 may be mounted to the secondary extractor assembly 78 to generate a suction force or vacuum sufficient to extract the waste 53 and force the waste 53 through the secondary extractor assembly 78. The separated fragments 51, heavier than the waste 53 expelled through the extractor 78, may then fall from the distal end 64 of the elevator 60. Typically, the fragments 51 may fall through a discharge opening 82 of the elevator assembly 52 into an external storage device (not shown), such as a cart, a trailer, a dumpster, etc.

During operation, the agricultural vehicle 10 travels throughout the agricultural field 20 to harvest sugarcane. After the height of the tip cutter 22 is adjusted (if utilized) by means of the arms 28, the binder disc 24 on the tip cutter assembly 22 may function to bind the sugarcane tips as the farm vehicle 10 proceeds through the field 20, while the cutter disc 26 cuts the leafy tips of the sugarcane stalks to dump them along both sides of the farm vehicle 10. As the stalks enter the row divider 30, the shoes 34 may set the operating width to determine the amount of sugarcane entering the throat of the farm vehicle, either fixedly or adjustably. The lollipops 32 then bind the stalks at the machine inlet to allow the tipping roller 36 to bend the stalks downward in conjunction with the action of the feed roller 38. Once the stalks are positioned at an angle as shown in FIG. 1, the base cutting assembly 42 can then cut the base of the stalks from the field 20. The cut stalks are then directed to the conveyor roller assembly 44.

The cut sugarcane stalks are transported rearward by the conveyor rollers 46, 48 which compress the stalks and harvested matter. At the downstream end of the conveyor roller assembly 44, the chopper assembly 50 cuts or chops the compacted sugarcane stalks into pieces or fragments 51. Conveyed waste 53 (e.g., dust, dirt, leaves, etc.) separated from the sugarcane fragments 51 are then extracted through the primary extractor assembly 54 using the suction created by the fan 56. The separated/washed fragments 51 then fall into the elevator assembly 52 and travel upward via the elevator 60 from its proximal end 62 to its distal end 64. During normal operation, once the fragments 51 reach the distal end 64 of the elevator 60, the fragments 51 fall through the discharge opening 82 to an external storage device. Similar to primary extractor assembly 54, waste is blown out of agricultural vehicle 10 through secondary extractor assembly 78 with the aid of extractor fan 80.

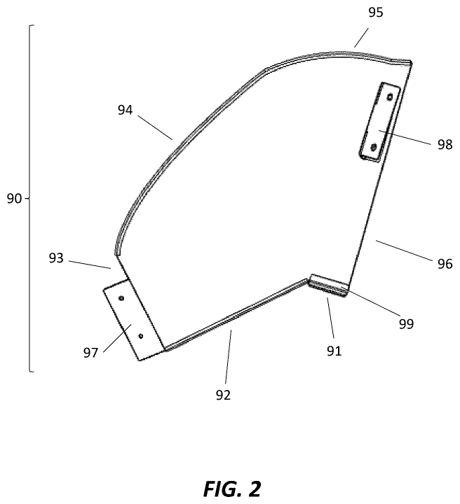

Reference is now made to FIG. 2, which illustrates a deflector 90, in accordance with aspects of the present subject matter, that may be installed in primary and secondary extractor assemblies 54, 78.

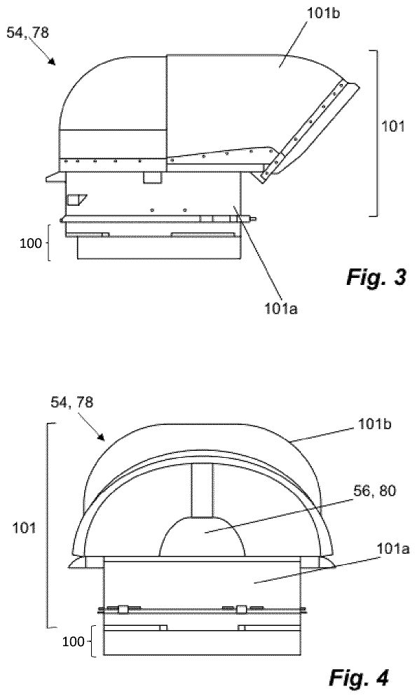

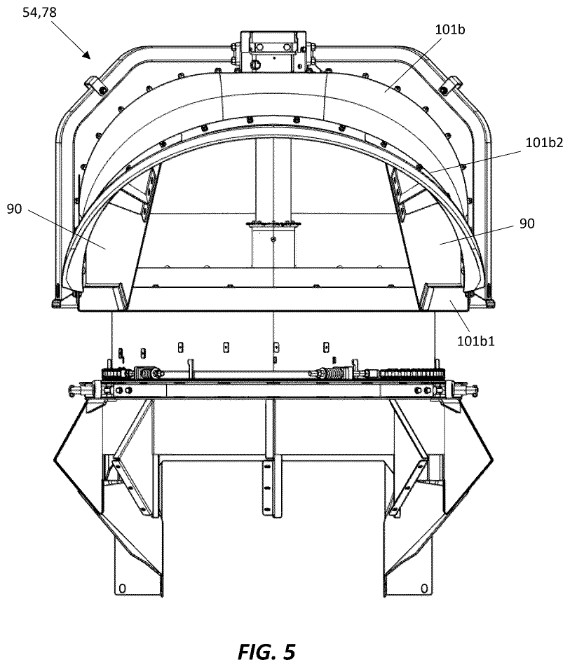

As can be seen in FIG. 2, the deflector 90 consists of a flat plate, which comprises a perimeter whose shape adapts to the geometry of the internal part of an extractor hood 101b of the extractor assembly 54, 78, such as that illustrated in FIGS. 3 to 6. The combined geometries of the deflector 90 and the extractor hood 101b allow the deflector to be installed in the extractor hood 101b without gaps between their surfaces. As can be seen in FIGS. 3 and 4, the extractor assembly 54, 78 also comprises a cleaning chamber 100, which is overlapped by a ventilation and extraction assembly 101, formed by a housing 101a within which a fan 56, 80 is installed, configured to direct harvest wastes through the extractor hood 101b.

As shown in FIG. 2, in order to have a shape corresponding to the geometry of the inner part of the extractor hood 101b, the perimeter of the flat baffle plate 90 may consist, for example, of a first perimeter section 91, a second perimeter section 92, a third perimeter section 93, a fourth perimeter section 94, a fifth perimeter section 95 and a sixth perimeter section 96.

The first perimeter section 91, the second perimeter section 92, the third perimeter section 93 and the sixth perimeter section 96 may comprise, for example, rectilinear segments. The rectilinear segments may be designed, for example, to tangent and seal the section of the extractor hood 101b with which they make contact. The fourth perimeter section 94 and the fifth perimeter section 95 may comprise, for example, curved segments.

The second perimeter section 92 may form an obtuse internal angle with the first perimeter section 91 and the third perimeter section 93, which may form an obtuse internal angle with the fourth perimeter section 94, which in turn may form an obtuse internal angle with the fifth perimeter section 95. The sixth perimeter section 96 may form an obtuse internal angle with the fifth perimeter section 95 and an acute internal angle with the first perimeter section 91.

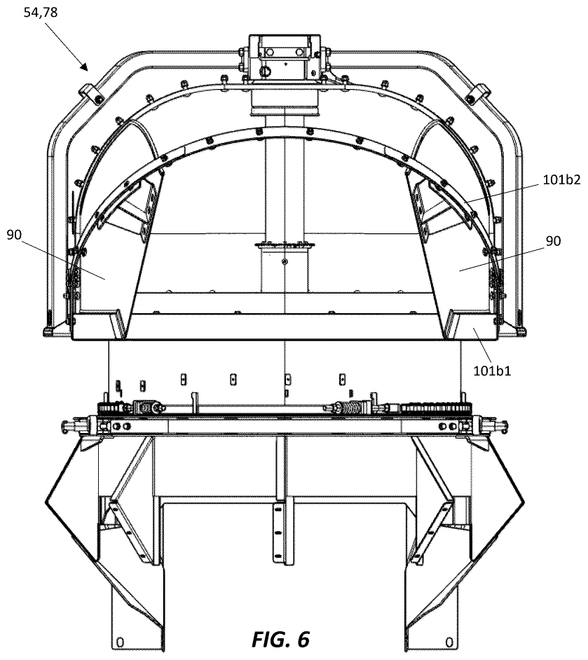

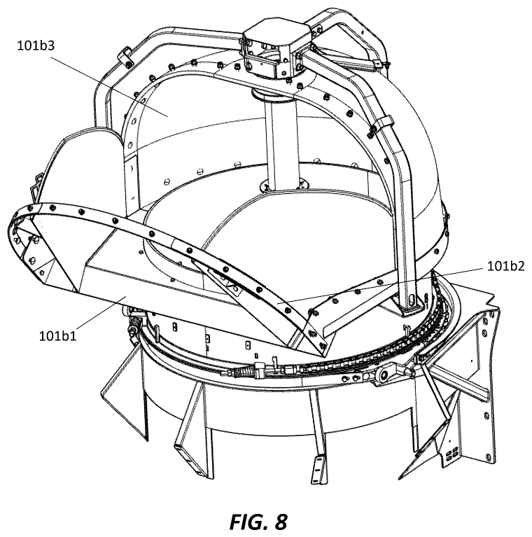

As can also be seen in FIG. 2, the first perimeter section 91 may comprise a flap 99. In addition, the second perimeter section 92, the fourth perimeter section 94 and the fifth perimeter section 95 may comprise trims. As can be seen in FIGS. 5 to 8, the first perimeter section 91 and the second perimeter section 92 may form a cutout whose shape conforms to the surface of a support bar 101b1 of the extractor hood 101b. Furthermore, as can also be seen in FIGS. 5 to 8, the fourth perimeter section 94 and the fifth perimeter section 95 may comprise a curvature configured to fit the curvature of an interior surface of the extractor hood 101b.

In other words, the first perimeter section 91, the second perimeter section 92, the fourth perimeter section 94 and the fifth perimeter section 95 may form contact surfaces with the extractor hood 101b. In this sense, the flap 99 that can be installed in the first perimeter section 91 acts as an auxiliary in fixing the deflectors 90 in the extractor hood 101b, minimizing the vibrations that the extractor assembly 54, 78 suffers and, thus, increasing the useful life of the system. In addition, the gaskets that can be installed in the second, fourth and fifth perimeter sections 92, 94, 95 ensure that there is no friction between the deflector 90 and the extractor hood 101b, so that there is no damage to either component in the event of inadvertent movement between the parts. In addition, the gaskets ensure sealing in the contact between the deflector 90 and the extractor hood 101b, so that the air flow is directed correctly.

In order to be installed safely and stably on the extractor hood 101b, the deflector 90 may further comprise a fixing plate 97 and a fixing assembly 98. The fixing plate 97 may have an angle of 10° to 20° in relation to a surface of the deflector 90, preferably an angle of 15°. The fixing assembly 98 may consist of a central plate, a first side plate, a second side plate and a transverse plate connecting the first side plate and the second side plate.

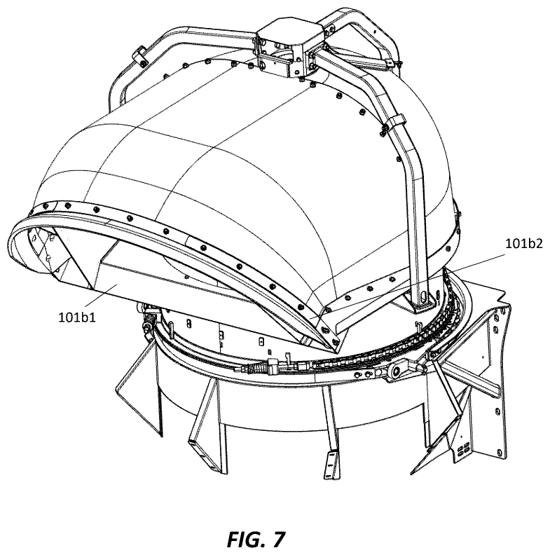

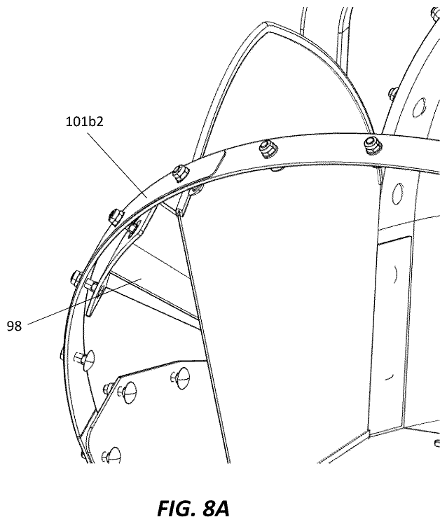

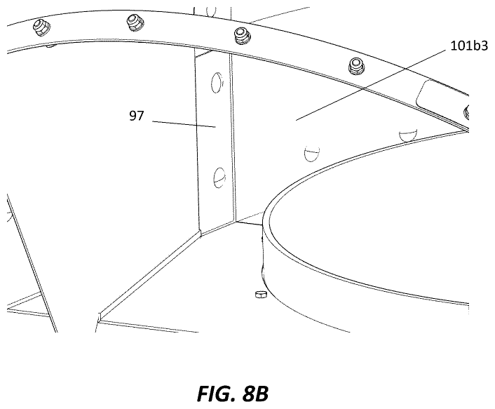

FIGS. 5 to 8, in particular FIGS. 6 and 8, in which the upper part of the extractor hood 101b has been removed for better viewing of the interior of the extractor assembly 54, 78, illustrate the fixing of the deflector 90 on the extractor hood 101b. In particular, the fixing plate 97 can be attached to a front internal surface 101b3 of the extractor hood 101b, while the fixing assembly 98 can be attached to a rear internal surface 101b2 of the extractor hood 101b. FIGS. 8A and 8B are close-up cutouts of FIG. 8 showing the fixing of the deflector 90 to the extractor hood 101b by means of, respectively, the fixing assembly 98 and the fixing plate 97.

It is noted that the fixing plate 97 and the fixing assembly 98 can be attached, respectively, to the front internal surface 101b3 and to the rear internal surface 101b2 by means of screws or adhesives or, alternatively, can be welded to the front and rear internal surfaces 101b3, 101b2.

As can be seen in FIGS. 5 to 8, a pair of deflectors 90 can be installed, symmetrically, on both sides of the extractor hood 101b. It should be noted that the pair of deflectors can be manufactured from a metallic material, a thermoplastic material or a combination of these, according to the compatibility required for attachment to the corresponding structures of the extractor hood 101b.

It is observed that the at least one deflector 90, as revealed throughout this descriptive report, when installed in the extractor hood 101b of an extractor assembly 54, 78 of an agricultural machine 10, causes the air that passes through the external walls of the extractor assembly 54, 78 to cross, which reduces the speed of the air flow and improves the mixing of the wastes, resulting in a more uniform waste exhaust, allowing a better direction of these wastes out of the agricultural machine 10. That is, by installing the at least one deflector 90 in the extractor hood 101b, the technical difficulties encountered in the extractor assemblies of the state of the art are resolved, namely, the concentration of light wastes on the left side of the extractor assembly and the consequent non-uniform spreading of the wastes.

This written description uses examples to describe the invention, including the best mode, and also to enable a person skilled in the art to practice the invention, including making and using any devices or systems and performing any methods embodied therein. The patentable scope of the invention is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1-16. (canceled)

17. An extractor assembly of waste for an agricultural machine, the extractor assembly comprising:
a cleaning chamber;
a ventilation and extraction assembly positioned above the cleaning chamber, the ventilation and extraction assembly including a housing and a fan installed within the housing, the ventilation and extraction assembly being configured to direct crop waste through an extractor hood;
at least one deflector having a flat plate defining a perimeter adapted to be coupled to the extractor hood, the at least one deflector further including a fixing plate and a fixing assembly,
wherein the at least one deflector is attached to the extractor hood.

18. The extractor assembly according to claim 17, wherein the at least one deflector is attached to the extractor hood by the fixing plate and the fixing assembly.

19. The extractor assembly according to claim 18, wherein the fixing plate is attached to a front internal surface of the extractor hood and the fixing assembly is attached to a rear internal surface of the extractor hood.

20. The extractor assembly according to claim 18, wherein the fixing plate is welded to a front internal surface of the extractor hood and the fixing assembly is welded to a rear internal surface of the extractor hood.

21. The extractor assembly according to claim 18, wherein the fixing plate is adhered to a front internal surface of the extractor hood and the fixing assembly is adhered to a rear internal surface of the extractor hood.

22. A deflector for an extractor assembly of an agricultural machine, the deflector comprising:
a flat plate defining a perimeter adapted to be coupled to an extractor hood of the extractor assembly of the agricultural machine;
a fixing plate; and
a fixing assembly.

23. The deflector according to claim 22, wherein the fixing plate defines an angle of 10° to 20° in relation to a surface of the deflector.

24. The deflector according to claim 22, wherein the perimeter of the flat plate includes a first perimeter section, a second perimeter section, a third perimeter section, a fourth perimeter section, a fifth perimeter section, and a sixth perimeter section.

25. The deflector according to claim 24, wherein:
the first perimeter section comprises a rectilinear segment;
the second perimeter section comprises a rectilinear segment and forms an obtuse internal angle with the first perimeter section;
the third perimeter section comprises a rectilinear segment and forms an obtuse internal angle with the second perimeter section;
the fourth perimeter section comprises a curved segment and forms an obtuse internal angle with the third perimeter section;
the fifth perimeter section comprises a curved segment and forms an obtuse internal angle with the fourth perimeter section; and
the sixth perimeter section comprises a rectilinear segment, forms an obtuse internal angle with the fifth perimeter section and forms an acute internal angle with the first perimeter section.

26. The deflector according to claim 24, wherein the first perimeter section comprises a flap.

27. The deflector according to claim 24, wherein the second perimeter section, the fourth perimeter section, and the fifth perimeter section comprise trims.

28. The deflector according to claim 24, wherein the first perimeter section and the second perimeter section form a cutout adapted to fit into a support bar of the extractor hood.

29. The deflector according to claim 24, wherein the fourth perimeter section and the fifth perimeter section define a curvature configured to fit the curvature of an interior surface of the extractor hood.

30. The deflector according to claim 22, wherein the fixing assembly comprises a central plate, a first side plate, a second side plate and a transverse plate connecting the first side plate and the second side plate.

31. The deflector according to claim 22, wherein the deflector is manufactured from a metallic material, a thermoplastic material or a combination thereof.

32. An agricultural machine for harvesting tall and stemmy plants, the agricultural machine including a chassis mounted on wheels or tracks, a motor, and an elevator comprising a proximal end and a distal end, the agricultural machine further comprising at least one extractor assembly as defined in claim 1, the at least one extractor assembly being installed relative to at least one of the proximal end or the distal end of the elevator.
